(19) United States
(12) Patent Application Publication
(10) Pub. No.: US 2010/0269513 A1
(43) Pub. Date: Oct. 28, 2010

(54) Thimble Fan for a Combustion System

(75) Inventors: Jonathan D. Berry, Simpsonville, SC (US); Russell DeForest, Simpsonville, SC (US); Hasan Karim, Simpsonville, SC (US)

Correspondence Address: SUTHERLAND ASBILL & BRENNAN LLP, 999 PEACHTREE STREET, N.E., ATLANTA, GA, 30309, US

(73) Assignee: GENERAL ELECTRIC COMPANY, Schnectady, NY (US)

(21) Appl. No.: 12/428,546

(22) Filed: Apr. 23, 2009

(51) Int. Cl. F23R 3/02; F02C 1/00

(52) U.S. Cl. 60/772; 60/752

(57) ABSTRACT

The present application describes a combustion liner. The combustion liner may include a number of air mixing holes and a number of thimble fans positioned thereon.

### TECHNICAL FIELD

The present application relates generally to gas turbine engines and more particularly relates to a thimble fan for use with a combustor liner and system so as to direct a flow of air towards the fuel stream to prevent hot gases from reaching the liner wall, mixing holes, and louvers.

### BACKGROUND OF THE INVENTION

In a gas turbine combustion system, the combustion chamber contains a liner that is typically of a tubular or an annular configuration with a closed end and an opposite open end. Fuel is ordinarily introduced into the liner via one or more fuel nozzles at or near the closed end while combustion air is admitted through circular rows of apertures or air mixing holes space axially and circumferentially along the liner. These gas turbine combustion liners usually operate at extremely high temperatures and depend to a large extent on the incoming combustion air from an appropriate compressor for cooling purposes.

Cracking around the combustion liner air mixing holes is a common problem for gas turbine combustor liners. In this regard, certain gas turbine engines use highly reactive fuels as the primary fuel source. Highly reactive fuels tend to pull the flame forward in the liner and anchor the flame both before (upstream) and after (downstream) the mixing row holes. This phenomena typically may be most pronounced about the first mixing hole row, i.e., at the end of the liner closest to the fuel nozzles. Additionally, low BTU fuels, and subsequently higher volume fuel flows, and highly reactive fuels may amplify these flame anchoring effects. Other typically used fuels also may cause the flame to anchor after or downstream of the mixing holes. Nevertheless, tests have confirmed that very high temperatures may exist on both sides of the mixing holes.

The problem of cracking has been addressed for locations downstream of the air mixing holes where the flame normally anchors. Inner air mixing hole inserts, referred to as refilmers have been used to establish a cooling flow film along the interior surface of the combustor liner downstream of the air mixing hole. Cracking problems along the upstream row of the air mixing holes, however, have not been addressed. In fact, the cooling film flow may be interrupted by the radial flow of air through these air mixing holes.

There is thus a desire for improved cooling air flow structures and techniques. These structures and techniques preferably may protect the upstream portions of the combustor liner from flames and heat which may result in durability issues including cracking, oxidation, creep deformation, thermal barrier coating spallation, etc.

### SUMMARY OF THE INVENTION

The present application thus provides a combustion liner. The combustion liner may include a number of air mixing holes and a number of thimble fans positioned thereon.

The present application further provides a method of operating a fuel nozzle within a combustion liner having a number of air mixing holes. The method may include the steps of positioning a number of angled slots on the combustion liner upstream of a first row of the air mixing holes, combusting a flow of fuel from the fuel nozzle within the combustion liner, and directing a flow of air through the angled slots to force the combusted flow of fuel away from the combustion liner wall.

The present application further provides a combustion system. The combustion system may include a combustion liner and a fuel nozzle in communication therewith. The combustion liner may include a number of air mixing holes positioned downstream of the fuel nozzle and a number of thimble fans positioned downstream of the fuel nozzle and upstream of the air mixing holes.

These and other features of the present application will become apparent to one of ordinary skill in the art upon review of the following detailed description when taken in conjunction with the several drawings and the appended claims.

### BRIEF DESCRIPTION OF THE DRAWINGS

FIG. 1 is a side plan view of a gas turbine combustor liner with a portion of the liner cap hardware and the transition piece also shown.

FIG. 2 is a perspective view of a combustor liner with the thimble fans installed as is described herein.

FIG. 3 is a front perspective view of the thimble fan as is shown in FIG. 2.

FIG. 4 is a side perspective view of the thimble fan as is described in FIG. 2.

FIG. 5 is a plan view of an alternative embodiment of the thimble fan as is described herein.

FIG. 6 is a plan view of an alternative embodiment of the thimble fan as is described herein.

FIG. 7A is a plan view of an alternative embodiment of the thimble fan as is described herein.

FIG. 7B is a plan view of an alternative embodiment of the thimble fan as is described herein.

FIG. 8 A is a plan view of an alternative embodiment of the thimble fan as is described herein.

FIG. 8B is a plan view of an alternative embodiment of the thimble fan as is described herein.

FIG. 9 is a perspective view of a combustion cap with a thimble fan positioned thereon.

### DETAILED DESCRIPTION

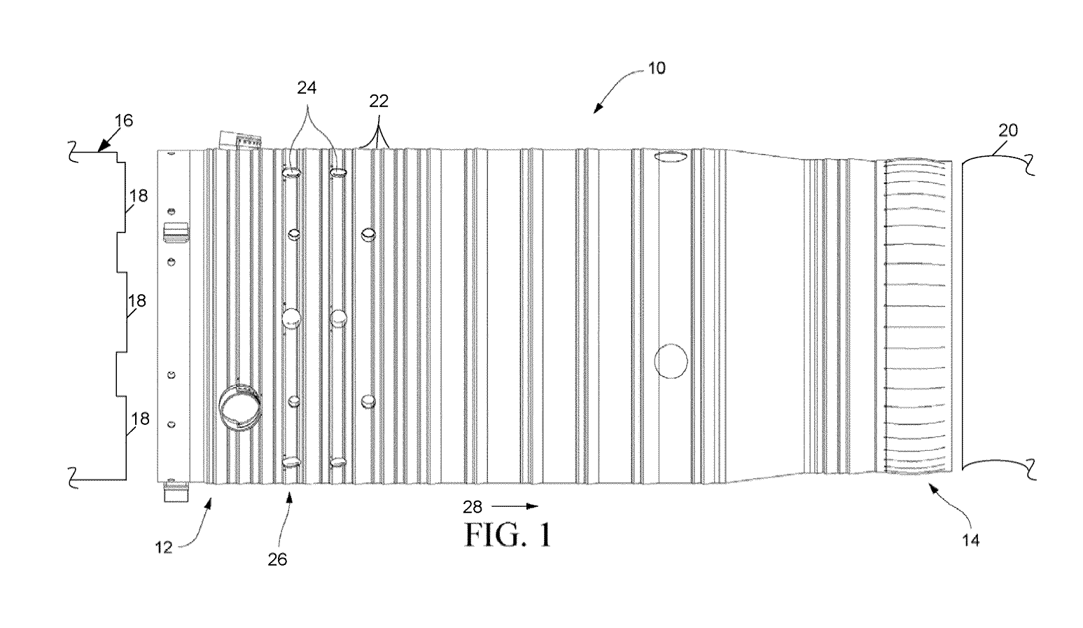

Referring now to the drawings, in which like numerals refer to like elements throughout the several views, FIG. 1 shows a conventional turbine combustor liner 10. The combustor liner 10 may include a generally cylindrical body having a forward end 12 and an aft end 14. The forward end 12 is typically enclosed by liner cap hardware 16 with one or more fuel injection nozzles 18 for supplying fuel to the combustor chamber within the liner 10. Any type or number of the fuel nozzles 18 may be used herein. The opposite aft end 14 of the liner 10 typically may be secured to a tubular transition piece 20 that supplies the hot combustion gases to the first stage of the turbine.

The liner 10 may have a number of slots 22 that may be fabricated by using a combination of brazing and welding techniques. The slots 22 may have a number of air cooling holes (not visible in FIG. 1) so as to provide a uniform circumferential distribution of cooling airflows known as film cooling. A number of axially spaced, circumferential rows of air distribution or air mixing holes 24 may be formed in the combustion liner 10 towards the forward end 12 of the liner 10, i.e., closer to the fuel nozzles 18. A first of the rows of air distribution or air mixing holes is shown at 26 and is discussed further below. The flow of combustion gases (inside the liner) is in a direction indicated by the flow arrow 28 with the combustion/diluent air being supplied radially and axially into the liner 10. The liner 10 and similar designs also may be applicable to any hot gas path component where cooling air is required.

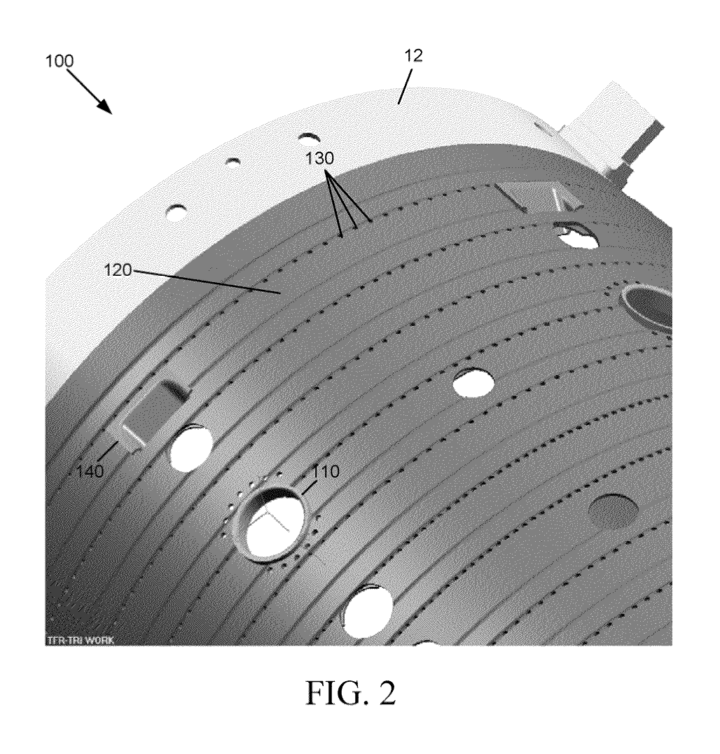

FIG. 2 shows a combustion liner 100 as is described above. Similar to the liner 10 described above, the combustion liner 100 includes the forward end 12 and the aft end 14. Likewise, the combustion liner 100 includes a number of air mixing holes 110 arranged circumferentially around the combustion liner 100. The combustion liner 100 also includes a number of slots 120 with a number of cooling holes 130 extending therethrough. Other types of apertures, such as spark plug holes, flame detection holes, and the like may be used.

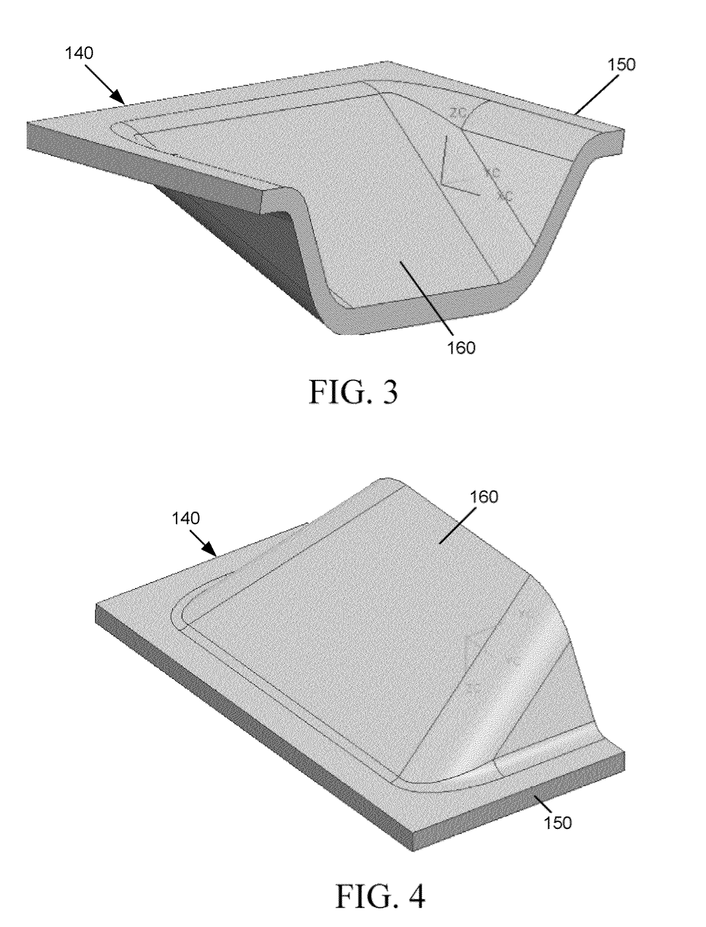

The combustion liner 100 may include a number of angled slots or thimble fans 140. As is shown in FIGS. 3 and 4, each thimble fan 140 may include a substantially flat outer lip 150 surrounding a downwardly inclining wall 160. The outer lip 150 may extend around the inclining wall 160 in whole or in part. The outer lip 150 of the thimble fans 140 may be attached to the combustion liner 100 via welding or other types of conventional techniques. The inclining wall 160 may have any desired angle of incline. The inclining wall 160 maybe substantially flat as is shown or may have any desired contour and/or shape. The thimble fans 140 may have any desired size. Specifically, the thimble fans 140 may have any shape that directs a flow of air at an angle into the combustion liner 100. Any number of thimble fans 140 may be used. The thimble fans 140 may be positioned anywhere and at any angle to the air mixing holes 110 along the combustion liner 100.

As is shown, the thimble fans 140 may be positioned upstream of the first row 26 of the airflow mixing holes 110. As described above, the air mixing holes 110 may interrupt the cooling airflow from the cooling holes 130. By positioning the thimble fans 140 upstream of the first row 26 of the mixing holes 110, the thimble fans 140 direct the airflow at the intersection of the fuel jet and the first row 26. Specifically, the airflow directed by the thimble fans 140 may prevent fuel and therefore flame from reaching the surface of the liner 100 so as to avoid localized overheating. Such a reduction should improve durability with respect to cracking, oxidation (specifically louver oxidation), creep deformation, thermal barrier coating spallation, etc. Durability issues about the adjacent cooling holes 130 also may be reduced. The thimble fans 140 thus should prevent overheating about the first row 26 of the air mixing holes 110 and both downstream and upstream thereof. The thimble fans 140 thus should increase the lifetime of the combustion liner 100.

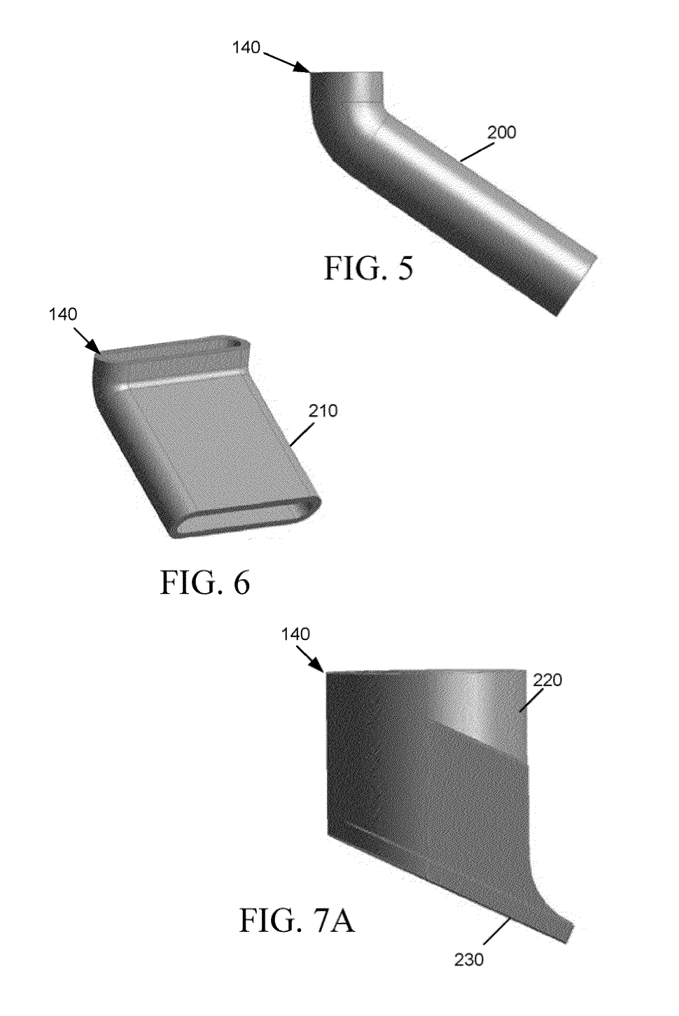

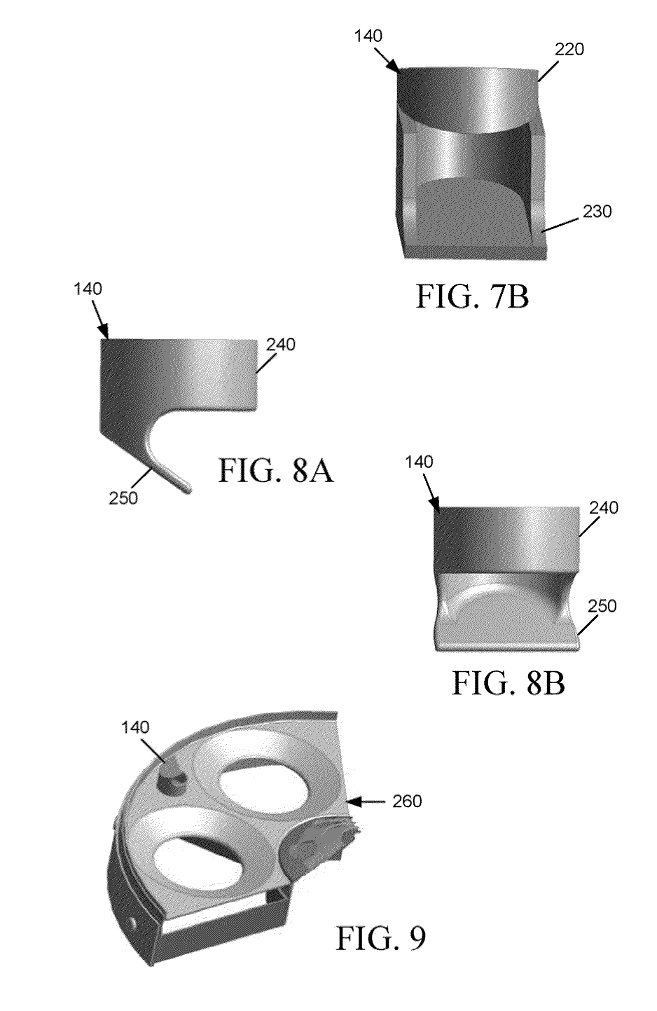

It is to be understood that the thimble fans 140 may take any desired size or shape. For example, FIG. 5 shows a thimble fan 140 in the form of an extended tube 200. FIG. 6 shows the thimble fan as an extended flattened tube 210. FIGS. 7A and 7B show a thimble fan 140 with a tube 220 leading to an angled flat surface 230. FIGS. 8A and 8B show a thimble fan 140 with a tube 240 extending to a partially extended angled flat surface 250. Many other designs may be used herein.

In addition to the combustion liner 100, the thimble fans 140 also may be positioned on a combustor cap 260. As is shown in FIG. 9, the combustor cap 260 may be positioned adjacent to the combustion liner 100. A number of thimble fans 140 may be positioned thereon. The thimble fans 140 may be positioned elsewhere.

It should be apparent that the foregoing relates only to certain embodiments of the present application and that numerous changes and modifications may be made herein by one of ordinary skill in the art without departing from the general spirit and scope of the invention as defined by the following claims and the equivalents thereof.

We claim:

1. A combustion liner, comprising:
a plurality of air mixing holes positioned thereon; and
a plurality of thimble fans positioned thereon.

2. The combustion liner of claim 1, wherein the plurality of air mixing holes comprises a first row of air mixing holes and wherein one or more of the plurality of thimble fans comprise a position upstream of the first row.

3. The combustion liner of claim 1, wherein the plurality of thimble fans comprises a downwardly inclining wall.

4. The combustion liner of claim 3, wherein the plurality of thimble fans comprises a substantially flat outer lip surrounding the downwardly inclining wall.

5. The combustion liner of claim 5, wherein the substantially flat outer lip surrounds the downwardly inclining wall in whole or in part.

6. The combustion liner of claim 1, further comprising a plurality of slots with a plurality of cooling holes.

7. The combustion liner of claim 1, further comprising a fuel nozzle in communication with the combustion liner and wherein the plurality of thimble fans is positioned downstream of the fuel nozzle.

8. The combustion liner of claim 1, wherein the plurality of thimble fans comprises a tube.

9. The combustion liner of claim 8, wherein the plurality of thimble fans comprises a flat surface extending from the tube.

10. A method of operating a fuel nozzle within a combustion liner having a number of air mixing holes, comprising:
positioning a plurality of angled slots on the combustion liner upstream of a first row of the number of air mixing holes;
combusting a flow of fuel from the fuel nozzle within the combustion liner; and
directing a flow of air through the plurality of angled spots to force the combusted flow of fuel away from the combustion liner wall.

11. The method of claim 10, wherein the combustion liner further comprises a plurality of cooling holes and wherein the method further comprises forcing the combusted flow of fuel away from the combustion liner about the plurality of cooling holes.

12. The method of claim 10, wherein the step of directing a flow of air through the plurality of angled slots to force the combusted flow of fuel away from the combustion liner about the first row of the number of air mixing holes comprises forcing the combusted flow of fuel away from the combustion liner both upstream and downstream of the first row of the number of air mixing holes.

13. The method of claim 10, wherein the step of directing a flow of air through the plurality of angled slots to force the combusted flow of fuel away from the combustion liner about the first row of the number of air mixing holes comprises reducing the temperature of the combustion liner about the first row of the number of air mixing holes.

14. The method of claim 10, wherein the step of directing a flow of air through the plurality of angled slots to force the combusted flow of fuel away from the combustion liner about the first row of the number of air mixing holes comprises reducing cracking about the first row of the number of air mixing holes.

15. A combustion system, comprising:
a combustion liner; and
a fuel nozzle in communication with the combustion liner,
the combustion liner comprising a plurality of air mixing holes positioned downstream of the fuel nozzle; and
the combustion liner comprising a plurality of thimble fans positioned downstream of the fuel nozzle and upstream of the plurality of air mixing holes.

16. The combustion system of claim 15, wherein the plurality of thimble fans comprises a downwardly inclining wall.

17. The combustion system of claim 16, wherein the plurality of thimble fans comprises a substantially flat outer lip surrounding the downwardly inclining wall.

18. The combustion system of claim 17, wherein the substantially flat outer lip surrounds the downwardly inclining wall in whole or in part.

19. The combustion system of claim 15, wherein the combustion liner comprises a plurality of slots with a plurality of cooling holes.

20. The combustion system of claim 15, further comprising a combustor cap and wherein one or more thimble fans are positioned thereon.
